(19) United States
(12) Patent Application Publication
(10) Pub. No.: US 2013/0062563 A1
(43) Pub. Date: Mar. 14, 2013

(54) FLUORESCENT MATERIALS USED IN FIELD EMISSION AND PREPARATION METHODS THEREOF

(71) Applicants: Mingjie Zhou, Shenzhen (CN); Yewen Wang, Shenzhen (CN); Ting Lu, Shenzhen (CN); Wenbo Ma, Shenzhen (CN)

(72) Inventors: Mingjie Zhou, Shenzhen (CN); Yewen Wang, Shenzhen (CN); Ting Lu, Shenzhen (CN); Wenbo Ma, Shenzhen (CN)

(21) Appl. No.: 13/699,602

(22) PCT Filed: May 25, 2010
(86) PCT No.: PCT/CN2010/073239

§ 371 Date: Nov. 21, 2012

(51) Int. Cl. C09K 11/80

(52) U.S. Cl. 252/301.6 R

(57) ABSTRACT

Fluorescent materials used in field emission and preparation methods thereof are provided. The said fluorescent materials are a mixture consisting of Zn₁₋ₓAlₓO, europium yttrium oxide or terbium yttrium oxide, wherein 0<x≦0.05. The said methods include the following steps: step 1, preparing Zn₁₋ₓAlₓO, wherein 0<x≦0.05; step 2, weighing yttrium oxide or yttrium oxalate and europium oxide or terbium oxide or oxalate thereof, grinding to form a mixture; step 3, mixing Zn₁₋ₓAlₓO with the mixture in step 2, stirring, drying to form a mixture; step 4, calcining the mixture in step 3 to form the said fluorescent material used in field emission. The fluorescent materials increase luminescent intensity and the said preparation methods have simple technique, low equipment requirement and short preparation cycle.

### BACKGROUND OF THE INVENTION

1. Field of the Invention

The present invention relates to the field of photoelectron and lighting technology, particularly to fluorescent materials which can be used in field emission luminescent devices and preparation methods thereof.

Field emission display (FED) is an emerging flat panel display. Similar to the working principle of conventional cathode-ray tube (CRT), FED forms images by electron beam bombardment of the phosphor on the display. The difference lies in the fact that CRT generates thermal electrons by heating the cathode, scans and addresses on fluorescent screen using electromagnetic field to control electronics biases; while in FED, from a macro perspective, the ejection of electrons are planar, electrons directly eject forward to the corresponding pixels and emit light without deflection coil, besides, the operating voltage is low, can be made into thin FED flat panel display (FPD). Compared with other FPD, FED has potential in luminance, visual angle, response time, working temperature range, energy consumption and other aspects. A key to prepare FED of high performances is to prepare fluorescent powder.

A usual fluorescent material used in FED is inorganic powder, which is of poor conductivity. The enrichment of electrons occurs easily on the surface of fluorescent powder when the beam current density of electron beam is so high. The enrichment of electrons lowers the voltage between FED cathode and fluorescent powder, decreases the energy of electron beam, resulting in decline in luminescent properties of fluorescent powder. So, the increase of conductivity of fluorescent powder is favorable for the improvement of the luminous performances of fluorescent powder. Therefore, how to improve the conductivity of the fluorescent powder has been an important part of the luminescent materials research in the field of materials chemistry and materials physics.

2. Summary of the Invention

The present invention aims at solving the technical problem of providing fluorescent materials used in field emission having simple technique, low demand on experimental conditions, which can also enhance the conductivity of fluorescent powders, and preparation methods thereof.

The technical solution to solve the technical problem of the present invention is: to provide fluorescent materials used in field emission, said fluorescent materials are a mixture consisting of Zn₁₋ₓAlₓO, and europium yttrium oxide or terbium yttrium oxide, wherein 0<x≦0.05. In the fluorescent materials of the present invention, said Zn₁₋ₓAlₓO accounts for 0.1 wt % to 30 wt % of europium yttrium oxide or terbium yttrium oxide; the molar ratio of said rare earth element yttrium to rare earth elements europium or terbium is in the range of 99.9:0.1 to 92:8.

And, preparation methods of fluorescent materials used in field emission, including the following steps:

step 1: preparing Zn₁₋ₓAlₓO, wherein 0<x≦0.05;

weighing yttrium oxide or yttrium oxalate, and europium oxide or europium oxalate or terbium oxide or terbium oxalate, then grinding to form a mixture;

step 3: mixing Zn₁₋ₓAlₓO obtained in step 1 with the mixture obtained in step 2, then stirring, drying to form a mixture consisting of Zn₁₋ₓAlₓO, yttrium oxide or yttrium oxalate, and europium oxide or europium oxalate or terbium oxide or terbium oxalate;

step 4: calcining the mixture obtained in step 3 to form a mixture consisting of Zn₁₋ₓAlₓO, and europium yttrium oxide or terbium yttrium oxide, said mixture obtained finally is said fluorescent material used in field emission.

In the preparation methods of the present invention, in said step 1, the preparation of Zn₁₋ₓAlₓO by using sol-gel method comprises: weighing raw materials of zinc salt and aluminum salt, and dissolving in solvent ethylene glycol monomethyl ether or ethanol, then adding one of the stabilizing agents including monoethanolamine, diethanol amine and triethanolamine to make Zn₁₋ₓAlₓO at a concentration of 0.05 to 0.70 mol/L, and stirring in a 40 to 70° C. water-bath for 4 to 6 h to obtain clarified precursor solution, placing into a 60° C. oven for an ageing lasting 56 to 90 h, to obtain said Zn₁₋ₓAlₓO.

In the preparation methods of the present invention, in the mixture obtained in step 2, the molar ratio of rare earth element yttrium to rare earth element europium or terbium is in the range of 99.9:0.1 to 92:8, said mixture is grinded in agate mortar for 5 to 120 min.

In the preparation methods of the present invention, in step 3, adding 0.15 mL to 1 mL of Zn₁₋ₓAlₓO into per gram of the mixture obtained in step 2, with the result that Zn₁₋ₓAlₓO accounts for 0.1 wt % to 30 wt % of europium yttrium oxide or terbium yttrium oxide, and stirring magnetically or manually in a 15 to 70° C. water-bath for 5 to 600 min, then placing into a 40 to 80° C. oven to dry for 5 to 30 h.

In the preparation methods of the present invention, in step 4, placing the mixture obtained finally in step 3 into a corundum crucible, then treating in the air atmosphere or reducing atmosphere at the temperature ranged from 700 to 1400° C. for 0.5 to 8 h.

In the preparation methods of the present invention, said reducing atmosphere is mixed gases of hydrogen and nitrogen, or reducing atmosphere formed by carbon powder, herein the volume ratio of hydrogen to nitrogen is 5:95.

By introduction of conductive substance Zn₁₋ₓAlₓO into the fluorescent powder of the present invention, electrons accumulated on the surface of the fluorescent powder can be effectively exported. As a result, the luminance of the prepared fluorescent powder of europium yttrium oxide or terbium yttrium oxide is increased under the excitation of cathode ray. In addition, the preparation methods of the present invention have simple technique, low equipment requirement and short preparation cycle.

### BRIEF DESCRIPTION OF THE DRAWINGS

Further description of the present invention will be illustrated, which combined with embodiments in the drawings:

FIG. 1 is a flow chart of the preparation methods of fluorescent materials used in field emission of the present invention;

FIG. 2 is a spectrum excited by cathode, herein curve 1 is the spectrum of sample prepared in Example 3, curve 2 is the spectrum of the sample without Zn₁₋ₓAlₓO.

### DETAILED DESCRIPTION OF ILLUSTRATED EMBODIMENTS

Further description of the present invention will be illustrated, which combined with embodiments in the drawings, in order to make the purpose, the technical solution and the advantages clearer. While the present invention has been described with reference to particular embodiments, it will be understood that the embodiments are illustrative and that the invention scope is not so limited.

The present invention provides fluorescent materials used in field emission, said fluorescent materials are a mixture consisting of Zn₁₋ₓAlₓO, and europium yttrium oxide or terbium yttrium oxide, wherein 0<x≦0.05. In the fluorescent materials of the present invention, said Zn₁₋ₓAlₓO accounts for 0.1 wt % to 30 wt % of europium yttrium oxide or terbium yttrium oxide; the molar ratio of said rare earth element yttrium to rare earth element europium or terbium is in the range of 99.9:0.1 to 92:8.

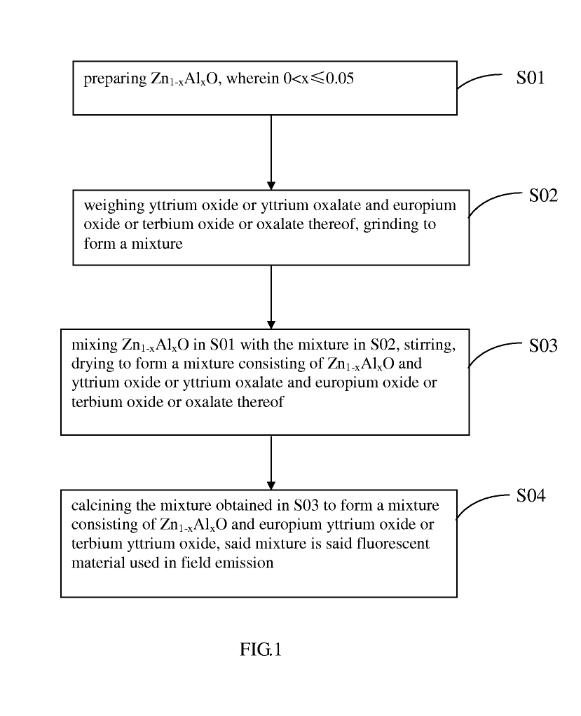

Referring to FIG. 1, it will be understood that FIG. 1 shows the process of the preparation methods of the present invention, the preparation methods comprise:

S01: preparing Zn₁₋ₓAlₓO, wherein 0<x≦0.05;

S02: weighing yttrium oxide or yttrium oxalate, and europium oxide or europium oxalate or terbium oxide or terbium oxalate, grinding to form a mixture;

S03: mixing Zn₁₋ₓAlₓO in S01 with the mixture obtained in S02, stirring, drying to form a mixture consisting of Zn₁₋ₓAlₓO, yttrium oxide or yttrium oxalate, and europium oxide or europium oxalate or terbium oxide or terbium oxalate;

S04: calcining the mixture obtained in S03 to form a mixture consisting of Zn₁₋ₓAlₓO, and europium yttrium oxide or terbium yttrium oxide, said mixture obtained finally is said fluorescent material used in field emission.

In the preparation methods of the present invention, in said S01, the preparation of Zn₁₋ₓAlₓO by using sol-gel method comprises: weighing raw materials of zinc salt and aluminum salt, and dissolving in solvent ethylene glycol monomethyl ether or ethanol, then adding one of the stabilizing agents including monoethanolamine, diethanol amine and triethanolamine to make Zn₁₋ₓAlₓO at a concentration of 0.05 to 0.70 mol/L, and stirring in a 40 to 70° C. water-bath for 4 to 6 h to obtain clarified precursor solution, placing into a 60° C. oven for an ageing lasting 56 to 90 h, to obtain said Zn₁₋ₓAlₓO.

In the preparation methods of the present invention, in the mixture obtained in S02, the molar ratio of rare earth element yttrium to rare earth element europium or terbium is in the range of 99.9:0.1 to 92:8, said mixture is grinded in agate mortar for 5 to 120 min. In the preparation methods of the present invention, in S03, adding 0.15 mL to 1 mL of Zn₁₋ₓAlₓO into per gram of the mixture obtained in S02, with the result that Zn₁₋ₓAlₓO accounts for 0.1 wt % to 30 wt % of europium yttrium oxide or terbium yttrium oxide, and stirring magnetically or manually in a 15 to 70° C. water-bath for 5 to 600 min, then placing into a 40 to 80° C. oven to dry for 5 to 30 h to obtain a mixture consisting of Zn₁₋ₓAlₓO, yttrium oxide or yttrium oxalate, and europium oxide or europium oxalate or terbium oxide or terbium oxalate. In S04, placing the mixture obtained finally in S03 into a corundum crucible, then treating in the air atmosphere or reducing atmosphere at the temperature ranged from 700 to 1400° C. for 0.5 to 8 h. Said reducing atmosphere can be mixed gases of hydrogen and nitrogen in a volume ratio of 5:95, or reducing atmosphere formed by carbon powder.

By introduction of conductive substance Zn₁₋ₓAlₓO into the fluorescent powder of the present invention, electrons accumulated on the surface of the fluorescent powder can be effectively exported. As a result, the luminance of the prepared fluorescent powder of europium yttrium oxide or terbium yttrium oxide is increased under the excitation of cathode ray. In addition, the preparation methods of the present invention have simple technique, low equipment requirement and short preparation cycle.

Special examples are disclosed as follows to demonstrate preparation methods of fluorescent materials used in field emission of the present invention and other properties.

### Example 1

At room temperature, 2.9452 g of Zn(NO₃)₂.6H₂O, 0.0241 g of AlCl₃.6H₂O, 0.6 mL of C₂H₇NO and 50 mL of ethylene glycol monomethyl were put in a container to obtain 0.20 mol/L mixed solution of zinc and aluminum. The mixed solution of zinc and aluminum was stirred in a 50° C. water-bath for 5 h to obtain clarified precursor solution, then ageing in a 60° C. oven for 56 h to obtain Zn_{0.99}Al_{0.01}O colloid.

2.1226 g of yttrium oxide, 0.2112 g of europium oxide were grinded in agate mortar for 50 min to obtain mixture of yttrium oxide and europium oxide. 0.40 mL of Zn_{0.99}Al_{0.01}O colloid and 2 g of mixture of yttrium oxide and europium oxide were stirred manually for 30 min, and then dried in a 60° C. oven for 10 h to obtain a mixture consisting of Zn_{0.99}Al_{0.01}O colloid and yttrium oxide and europium oxide. Said mixture was placed into a corundum crucible, treated in air atmosphere at 900° C. for 3 h, then a mixture consisting of Zn_{0.99}Al_{0.01}O and europium yttrium oxide was obtained. The obtained mixture is fluorescent materials used in field emission.

### Example 2

At room temperature, 2.4810 g of ZnCl₂.2H₂O, 0.1448 g of AlCl₃.6H₂O, 1.5 mL of C₄H₁₁NO₂ and 50 mL of mixed solution of ethanol and water with a volume ratio of 3:1 were put in a container to obtain 0.30 mol/L mixed solution of zinc and aluminum. The mixed solution of zinc and aluminum was stirred in a 60° C. water-bath for 6 h to obtain clarified precursor solution, then ageing in a 60° C. oven for 70 h to obtain Zn_{0.96}Al_{0.04}O colloid.

9.0234 g of yttrium oxide, 0.0141 g of europium oxide were grinded in agate mortar for 120 min to obtain mixture of yttrium oxide and europium oxide. 0.80 mL of Zn_{0.96}Al_{0.04}O colloid and 2 g of mixture of yttrium oxide and europium oxide were stirred manually for 5 min, and then dried in a 40° C. oven for 30 h to obtain a mixture consisting of Zn_{0.96}Al_{0.04}O colloid and yttrium oxide and europium oxide. Said mixture was placed into a corundum crucible, treated in air atmosphere at 700° C. for 8 h, then a mixture consisting of Zn_{0.96}Al_{0.04}O and europium yttrium oxide was obtained. The obtained mixture is fluorescent materials used in field emission.

### Example 3

At room temperature, 0.5460 g of Zn(CH₃COO)₂.2H₂O, 0.0047 g of Al(NO₃)₃.9H₂O, 0.4 mL of C₆H₁₅O₃N and 50 mL of mixed solution of ethanol and water with a volume ratio of 4:1 were put in a container to obtain 0.05 mol/L mixed solution of zinc and aluminum. The mixed solution of zinc and aluminum was stirred in a 70° C. water-bath for 4 h to obtain clarified precursor solution, then ageing in a 60° C. oven for 90 h to obtain Zn_{0.995}Al_{0.005}O colloid.

2.1452 g of yttrium oxide, 0.1760 g of europium oxide were grinded in agate mortar for 80 min to obtain mixture of yttrium oxide and europium oxide. 0.30 mL of Zn_{0.995}Al_{0.005}O colloid and 2 g of mixture of yttrium oxide and europium oxide were stirred magnetically for 10 h, and then dried in a 80° C. oven for 5 h to obtain a mixture consisting of Zn_{0.995}Al_{0.005}O colloid and yttrium oxide and europium oxide. Said mixture was placed into a corundum crucible, treated in air atmosphere at 1400° C. for 0.5 h, then a mixture consisting of Zn_{0.995}Al_{0.005}O and europium yttrium oxide was obtained. The obtained mixture is fluorescent materials used in field emission.

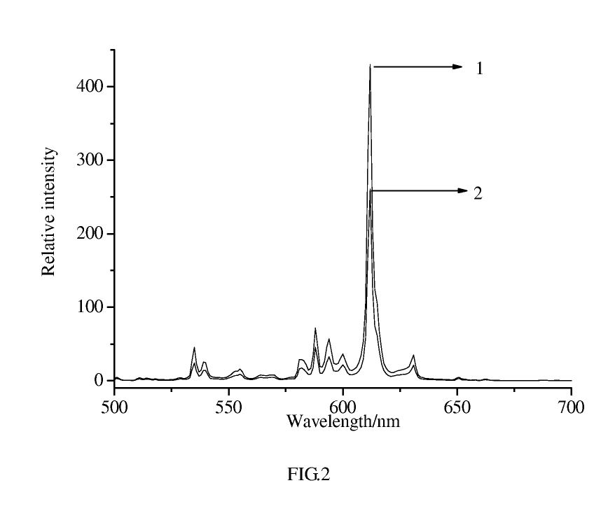

Referring to FIG. 2, curve 1 is the spectrum of sample prepared in Example 3, curve 2 is the spectrum of the sample without Zn₁₋ₓAlₓO. It can be seen that the luminescent intensity of sample prepared in Example 3 is 1.73 times that of the sample without Zn₁₋ₓAlₓO in the range of 500 nm to 700 nm.

### Example 4

At room temperature, 1.0865 g of Zn(CH₃COO)₂.2H₂O, 0.0188 g of Al(NO₃)₃.9H₂O, 0.4 mL of C₂H₇NO and 50 mL of mixed solution of ethanol and water with a volume ratio of 5:1 were put in a container to obtain 0.10 mol/L mixed solution of zinc and aluminum. The mixed solution of zinc and aluminum was stirred in a 40° C. water-bath for 5 h to obtain clarified precursor solution, then ageing in a 60° C. oven for 80 h to obtain Zn_{0.99}Al_{0.01}O colloid.

2.0775 g of yttrium oxide, 0.2815 g of europium oxide were grinded in agate mortar for 5 min to obtain mixture of yttrium oxide and europium oxide. 0.9 mL of Zn_{0.99}Al_{0.01}O colloid and 2 g of mixture of yttrium oxide and europium oxide were stirred magnetically for 3 h, and then dried in a 50° C. oven for 20 h to obtain a mixture consisting of Zn_{0.99}Al_{0.01}O colloid and yttrium oxide and europium oxide. Said mixture was placed into a corundum crucible, treated in air atmosphere at 1200° C. for 2 h, then a mixture consisting of Zn_{0.99}Al_{0.01}O and europium yttrium oxide was obtained. The obtained mixture is fluorescent materials used in field emission.

### Example 5

At room temperature, 2. 1292 g of Zn(CH₃COO)₂.2H₂O, 0.1125 g of Al(NO₃)₃.9H₂O, 0.6 mL of C₂H₇NO and 50 mL of ethylene glycol monomethyl were put in a container to obtain 0.20 mol/L mixed solution of zinc and aluminum. The mixed solution of zinc and aluminum was stirred in a 60° C. water-bath for 5 h to obtain clarified precursor solution, then ageing in a 60° C. oven for 75 h to obtain Zn_{0.97}Al_{0.03}O colloid.

2.2129 g of yttrium oxide, 0.0748 g of terbium oxide were grinded in agate mortar for 30 min to obtain mixture of yttrium oxide and terbium oxide. 2 mL of Zn_{0.97}Al_{0.03}O colloid and 2 g of mixture of yttrium oxide and terbium oxide were stirred magnetically for 5 h, and then dried in a 70° C. oven for 20 h to obtain a mixture consisting of Zn_{0.97}Al_{0.03}O colloid and yttrium oxide and terbium oxide. Said mixture was placed into a corundum crucible, treated in reducing atmosphere formed by carbon powder at 1000° C. for 3 h, then a mixture consisting of Zn_{0.97}Al_{0.03}O and terbium yttrium oxide was obtained. The obtained mixture is fluorescent materials used in field emission.

### Example 6

At room temperature, 3.1937 g of Zn(CH₃COO)₂.2H₂O, 0.1688 g of Al(NO₃)₃.9H₂O, 0.9 mL of C₂H₇NO and 50 mL of ethylene glycol monomethyl were put in a container to obtain 0.30 mol/L mixed solution of zinc and aluminum. The mixed solution of zinc and aluminum was stirred in a 60° C. water-bath for 4 h to obtain clarified precursor solution, then ageing in a 60° C. oven for 65 h to obtain Zn_{0.97}Al_{0.03}O colloid.

5.6776 g of yttrium oxalate, 0.4128 g of europium oxalate were grinded in agate mortar for 70 min to obtain mixture of yttrium oxalate and europium oxalate. 1 mL of Zn_{0.97}Al_{0.03}O colloid and 2 g of mixture of yttrium oxalate and europium oxalate were stirred magnetically for 8 h, and then dried in a 70° C. oven for 15 h to obtain a mixture consisting of Zn_{0.97}Al_{0.03}O colloid and yttrium oxalate and europium oxalate. Said mixture was placed into a corundum crucible, treated in air atmosphere at 900° C. for 5 h, then a mixture consisting of Zn_{0.97}Al_{0.03}O and europium yttrium oxide was obtained. The obtained mixture is fluorescent materials used in field emission.

### Example 7

At room temperature, 4.2583 g of Zn(CH₃COO)₂.2H₂O, 0.2251 g of Al(NO₃)₃.9H₂O, 2 mL of C₄H₁₁NO₂ and 50 mL of ethylene glycol monomethyl were put in a container to obtain 0.40 mol/L mixed solution of zinc and aluminum. The mixed solution of zinc and aluminum was stirred in a 60° C. water-bath for 6 h to obtain clarified precursor solution, then ageing in a 60° C. oven for 78 h to obtain Zn_{0.97}Al_{0.03}O colloid.

5.9192 g of yttrium oxalate, 0.1404 g of terbium oxalate were grinded in agate mortar for 100 min to obtain mixture of yttrium oxalate and terbium oxalate. 0.6 mL of Zn_{0.97}Al_{0.03}O colloid and 2 g of mixture of yttrium oxalate and terbium oxalate were stirred magnetically for 8 h, and then dried in a 70° C. oven for 15 h to obtain a mixture consisting of Zn_{0.97}Al_{0.03}O colloid and yttrium oxalate and terbium oxalate. Said mixture was placed into a corundum crucible, treated in mixed gases of nitrogen and hydrogen with a volume ratio of 95:5 at 900° C. for 5 h, then a mixture consisting of Zn_{0.97}Al_{0.03}O and terbium yttrium oxide was obtained. The obtained mixture is fluorescent materials used in field emission.

### Example 8

At room temperature, 7.2984 g of Zn(CH₃COO)₂.2H₂O, 0.6565 g of Al(NO₃)₃.9H₂O, 2 mL of C₂H₇NO and 50 mL of mixed solution of ethanol and water with a volume ratio of 6:1 were put in a container to obtain 0.70 mol/L mixed solution of zinc and aluminum. The mixed solution of zinc and aluminum was stirred in a 50° C. water-bath for 4 h to obtain clarified precursor solution, then ageing in a 60° C. oven for 85 h to obtain Zn_{0.95}Al_{0.05}O colloid.

5.6776 g of yttrium oxalate, 0.0748 g of terbium oxide were grinded in agate mortar for 90 min to obtain mixture of yttrium oxalate and terbium oxide. 1.5 mL of Zn_{0.95}Al_{0.05}O colloid and 2 g of mixture of compounds of yttrium and terbium were stirred magnetically for 8 h, and then dried in a 60° C. oven for 12 h to obtain a mixture consisting of Zn_{0.95}Al_{0.05}O colloid and yttrium oxalate and terbium oxide. Said mixture was placed into a corundum crucible, treated in mixed gases of nitrogen and hydrogen with a volume ratio of 95:5 at 900° C. for 5 h, then a mixture consisting of Zn_{0.95}Al_{0.05}O and europium yttrium oxide was obtained. The obtained mixture is fluorescent materials used in field emission.

### Example 9

At room temperature, 6.9733 g of ZnSO₄.7H₂O, 0.1283 g of Al₂(SO₄)₃, 1.5 mL of C₂H₇NO and 50 mL of mixed solution of ethanol and water with a volume ratio of 7:1 were put in a container to obtain 0.50 mol/L mixed solution of zinc and aluminum. The mixed solution of zinc and aluminum was stirred in a 60° C. water-bath for 6 h to obtain clarified precursor solution, then ageing in a 60° C. oven for 90 h to obtain Zn_{0.97}Al_{0.03}O colloid.

2.1226 g of yttrium oxide, 0.2112 g of europium oxide were grinded in agate mortar for 60 min to obtain mixture of yttrium oxide and europium oxide. 0.7 mL of Zn_{0.97}Al_{0.03}O colloid and 2 g of mixture of yttrium oxide and europium oxide were stirred magnetically for 4 h, and then dried in a 70° C. oven for 15 h to obtain a mixture consisting of Zn_{0.97}Al_{0.03}O colloid and yttrium oxide and europium oxide. Said mixture was placed into a corundum crucible, treated in air atmosphere at 800° C. for 5 h, then a mixture consisting of Zn_{0.97}Al_{0.03}O and europium yttrium oxide was obtained. The obtained mixture is fluorescent materials used in field emission.

### Example 10

At room temperature, 9.6620 g of ZnSO₄.7H₂O, 0.2395 g of Al₂(SO₄)₃, 4.7 mL of C₆H₁₅O₃N and 50 mL of ethylene glycol monomethyl were put in a container to obtain 0.70 mol/L mixed solution of zinc and aluminum. The mixed solution of zinc and aluminum was stirred in a 60° C. water-bath for 46 h to obtain clarified precursor solution, then ageing in a 60° C. oven for 60 h to obtain Zn_{0.96}Al_{0.04}O colloid.

2.1452 g of yttrium oxide, 0.1760 g of europium oxide were grinded in agate mortar for 20 min to obtain mixture of yttrium oxide and europium oxide. 0.7 mL of Zn_{0.96}Al_{0.04}O colloid and 2 g of mixture of yttrium oxide and europium oxide were stirred magnetically for 4 h, and then dried in a 70° C. oven for 8 h to obtain a mixture consisting of Zn_{0.96}Al_{0.04}O colloid and yttrium oxide and europium oxide. Said mixture was placed into a corundum crucible, treated in air atmosphere at 900° C. for 5 h, then a mixture consisting of Zn_{0.96}Al_{0.04}O and europium yttrium oxide was obtained. The obtained mixture is fluorescent materials used in field emission.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. Fluorescent materials used in field emission, wherein said fluorescent materials are a mixture consisting of Zn₁₋ₓAlₓO, and europium yttrium oxide or terbium yttrium oxide, wherein 0<x≦0.05.

2. Fluorescent materials used in field emission as in claim 1, wherein said Zn₁₋ₓAlₓO accounts for 0.1 wt % to 30 wt % of europium yttrium oxide or terbium yttrium oxide.

3. Fluorescent materials used in field emission as in claim 1, wherein the molar ratio of said rare earth element yttrium to rare earth elements europium or terbium is in the range of 99.9:0.1 to 92:8.

4. Preparation methods of fluorescent materials used in field emission, including the following steps:
step 1: preparing Zn₁₋ₓAlₓO, wherein 0<x≦0.05;
step 2: weighing yttrium oxide or yttrium oxalate, and europium oxide or europium oxalate or terbium oxide or terbium oxalate, grinding to form a mixture;
step 3: mixing Zn₁₋ₓAlₓO in step 1 with the mixture obtained in step 2, stirring, drying to form a mixture consisting of Zn₁₋ₓAlₓO, yttrium oxide or yttrium oxalate, and europium oxide or europium oxalate or terbium oxide or terbium oxalate;
step 4: calcining the mixture obtained in step 3 to form a mixture consisting of Zn₁₋ₓAlₓO, and europium yttrium oxide or terbium yttrium oxide, said mixture obtained finally is said fluorescent material used in field emission.

5. Preparation methods of fluorescent materials used in field emission as in claim 4, wherein in said step 1, the preparation of Zn₁₋ₓAlₓO by using sol-gel method comprises: weighing raw materials of zinc salt and aluminum salt, and dissolving in solvent ethylene glycol monomethyl ether or ethanol, then adding one of the stabilizing agents including monoethanolamine, diethanol amine and triethanolamine to make Zn₁₋ₓAlₓO at a concentration of 0.05 to 0.70 mol/L, and stirring in a 40 to 70° C. water-bath for 4 to 6 h to obtain clarified precursor solution, placing into a 60° C. oven for an ageing lasting 56 to 90 h, to obtain said Zn₁₋ₓAlₓO.

6. Preparation methods of fluorescent materials used in field emission as in claim 4, wherein in the mixture obtained in step 2, the molar ratio of rare earth element yttrium to rare earth elements europium or terbium is in the range of 99.9:0.1 to 92:8, said mixture is grinded in agate mortar for 5 to 120 min.

7. Preparation methods of fluorescent materials used in field emission as in claim 4, wherein in step 3, adding 0.15 mL to 1 mL of Zn₁₋ₓAlₓO into per gram of the mixture obtained in step 2, with the result that Zn₁₋ₓAlₓO accounts for 0.1 wt % to 30 wt % of europium yttrium oxide or terbium yttrium oxide, and stirring magnetically or manually in a 15 to 70° C. water-bath for 5 to 600 min, then placing into a 40 to 80° C. oven to dry for 5 to 30 h.

8. Preparation methods of fluorescent materials used in field emission as in claim 4, wherein in step 4, placing the mixture obtained finally in step 3 into a corundum crucible, then treating in the air atmosphere or reducing atmosphere at the temperature ranged from 700 to 1400° C. for 0.5 to 8 h.

9. Preparation methods of fluorescent materials used in field emission as in claim 8, wherein said reducing atmosphere is mixed gases of hydrogen and nitrogen, or reducing atmosphere formed by carbon powder.

10. Preparation methods of fluorescent materials used in field emission as in claim 9, wherein the volume ratio of hydrogen to nitrogen is 5:95.
